(19) United States
(12) Patent Application Publication
(10) Pub. No.: US 2007/0131492 A1
(43) Pub. Date: Jun. 14, 2007

(54) Brake lining wear sensor between lining blocks

(75) Inventors: Thomas Michael Cory, Sterling Heights, MI (US); Bruce V. Harris, Shelby Township, MI (US); Joseph A. Kay, Highland, MI (US); Dacio de Gonzaga Paul, Sterling Heights, MI (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/371,473

(22) Filed: Mar. 9, 2006

Related U.S. Application Data
(63) Continuation-in-part of application No. 11/302,023, filed on Dec. 13, 2005.

(51) Int. Cl. F16D 66/02

(52) U.S. Cl. 188/1.11 L

(57) ABSTRACT

A brake lining wear sensor includes a first portion attached to a brake lining support plate, a second portion that engages a rotating brake component after brake lining material wears to a predetermined wear level, and an internal bore that extends through the first and said second portions. A sensor wire is received within the internal bore and includes a looped portion positioned within the second portion such that the looped portion is held at a predetermined brake lining wear level limit. When the looped portion is broken due to contact with a rotating brake component, a warning signal is communicated to an operator to indicate that a wear limit has been reached.

### RELATED APPLICATION

This application is a continuation-in-part application claiming priority to U.S. application Ser. No. 11/302,023 filed on Dec. 13, 2005.

### TECHNICAL FIELD

The subject invention relates to a brake lining wear sensor that includes a first portion attached to a brake lining support plate and second portion that holds a single looped sensor wire that generates a warning signal when broken to indicate when vehicle brake linings should be replaced.

### BACKGROUND OF THE INVENTION

Brake lining wear sensors are used to indicate that brake linings have worn to a level where the brake linings should be replaced. There are many different types of brake lining wear sensors including electrical sensors and purely mechanical sensors. One type of mechanical sensor generates an audible squeaking noise that indicates linings should be replaced. These types of sensors are disadvantageous for heavy vehicle applications as audible noise is difficult to hear during vehicle operation. Another type of mechanical sensor requires constant visual checking at each pad location. This is tedious and time consuming.

These types of mechanical sensors are not preferred because operators may not perform visual inspections in a timely manner. This can result in the brake linings wearing down too far, and potentially exposing rivets that hold the brake linings to an associated support plate. If the rivets are exposed, they could contact and damage the rotating brake drum.

Electrical sensors have also been used for brake lining wear sensors. These types of sensors are often complicated and are used to continuously monitor and calculate wear of the brake lining material at multiple, different, wear levels. These types of sensors are also often embedded within brake lining material, which increases cost and assembly time of an associated brake shoe assembly.

Thus, there is a need for a simplified electrical brake lining wear sensor that is low cost and can be easily installed, as well as overcoming the other identified deficiencies of the prior art.

### SUMMARY OF THE INVENTION

A brake lining wear sensor includes a first portion attached to a brake lining support plate, a second portion that engages a rotating brake component after brake lining material wears to a predetermined wear level, and an internal bore extending through the first and second portions. A sensor wire is received within the internal bore and includes a looped portion positioned within the second portion such that the looped portion is held at a predetermined brake lining wear level limit. When the rotating brake component contacts and breaks the looped portion, a warning signal is generated to indicate that brake linings should be replaced.

In one example, the first portion and the second portion are integrally formed together as a single piece component. The single piece component is secured to the brake lining support plate between adjacent brake lining blocks such that the brake lining wear sensor is not embedded in brake lining material. The single piece component is preferably formed from a thermoplastic material such that further contact between the brake lining wear sensor and the rotating brake component, after the looped portion has been broken, does not damage the rotating brake component.

In another example, the first portion comprises a hollow rivet body that is used to secure the brake lining to the brake lining support plate. The second portion comprises an insert that is at least partially received within the hollow rivet body. The second portion extends into a rivet opening formed in the brake lining such that the second portion is substantially surrounded by brake lining material. The looped portion is received within the insert.

The subject invention provides a simple, low-cost brake lining wear sensor that is easily installed into a brake assembly, and which can be easily incorporated into existing vehicle electronic control systems. These and other features of the present invention can be best understood from the following specification and drawings, the following of which is a brief description.

### BRIEF DESCRIPTION OF THE DRAWINGS

FIG. 1 is a schematic view of a drum brake with a brake lining wear sensor incorporating the subject invention.

FIG. 2 is an exploded view of a brake lining wear sensor incorporating the subject invention.

FIG. 3 is an assembled view of the brake lining wear sensor of FIG. 2.

FIG. 4 is top view of the brake lining wear sensor of FIG. 2 installed in a brake shoe.

FIG. 5 is a side view of the brake lining wear sensor of FIG. 4.

FIG. 6 is a cross-sectional view of the brake lining sensor of FIG. 5.

FIG. 7 comprises an exploded view of another brake lining wear sensor incorporating the subject invention.

FIG. 8A is an assembled view of the brake lining wear sensor shown in FIG. 7.

FIG. 8B is a partial cross-sectional view of the brake lining wear sensor shown in FIG. 8A.

FIG. 9A is a view similar to that of 8A but rotated ninety degrees about an axis extending along a length of the brake lining wear sensor.

FIG. 9B is a partial cross-sectional view of the brake lining wear sensor shown in FIG. 9A.

FIG. 10 is a cross-sectional view of the brake lining wear sensor of FIGS. 8A-9B installed in a brake lining block.

### DETAILED DESCRIPTION OF THE PREFERRED EMBODIMENT

A drum brake 10 includes brake shoes 12 that selectively engage a rotating brake drum 14 in response to a braking request. Each brake shoe 12 includes a plate 16 that supports a brake lining 18. The brake lining 18 is preferably formed as a plurality of brake lining blocks 18a, 18b that are spaced apart from each other along the plate 16.

The brake lining 18 includes a lining surface 20 that engages an inner surface 22 of the brake drum 14 during each braking actuation. An actuator A is used to move the brake shoes 12 into engagement with the brake drum 14. Any type of actuator A could be used to actuate the brake shoes 12, such as a cam, hydraulic cylinder, etc., for example. Contact between the brake lining 18 and the brake drum 14 results in wear of the brake lining 18. As the brake lining 18 wears, the thickness of brake lining material decreases.

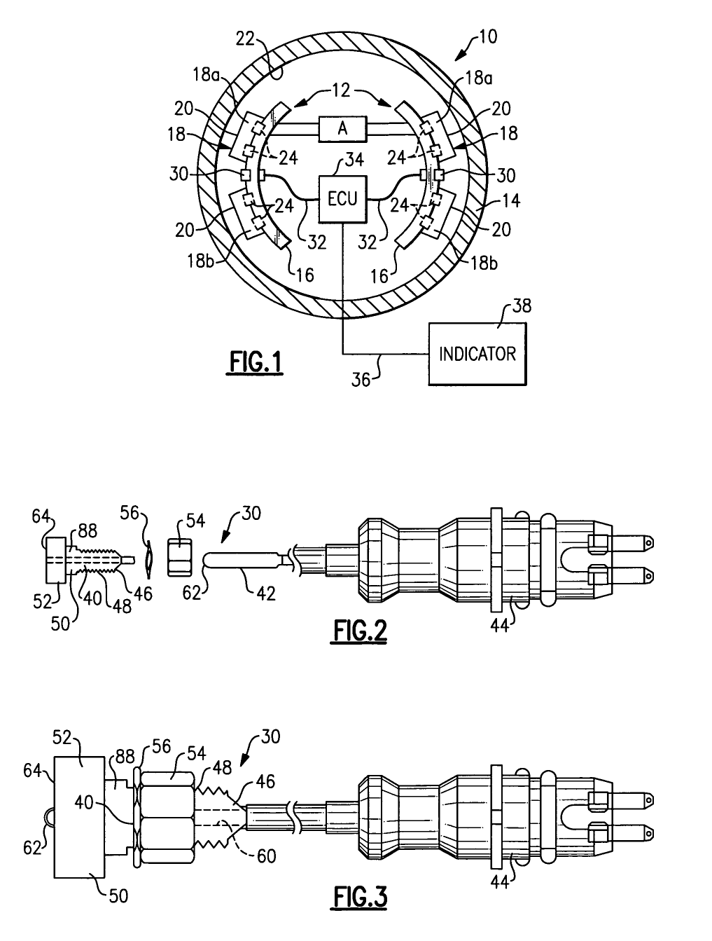

The brake shoes 12 need to be replaced before the brake linings 18 wear out. Typically each brake lining block 18a, 18b is attached to the plate 16 with a plurality of rivets 24 (schematically shown in FIG. 1). If the brake lining material wears below the height of the rivets 24, then the rivets 24 could contact the inner surface 22 of the brake drum 14 during brake applications. This could cause damage to the brake drum 14.

In order to avoid damaging the brake drum 14 and to notify an operator when the brake linings 18 have worn to a predetermined maximum brake lining wear level limit, the drum brake 10 includes a brake lining wear sensor 30 that is attached to the plate 16 of each brake shoe 12.

When the brake linings 18 have worn to the predetermined maximum brake lining wear level the brake lining wear sensor 30 generates a signal 32 that is transmitted or otherwise communicated to an electronic control unit (ECU) 34. The ECU 34 then generates a warning signal 36 that is communicated to the operator by a warning indicator 38, such as a lamp, display screen, alarm beep, etc.

The brake lining wear sensor 30 is shown in greater detail in FIGS. 2-6. The brake lining wear sensor 30 includes a body 40 and a sensor wire 42 that is coupled to an electrical connector 44 that is electrically connected to the ECU 34. The body 40 includes a first portion 46 supported by the plate 16 and a second portion 50 that is positioned for contact with a rotating brake component. In the example shown, the first 46 and second 50 portions are integrally formed together as a single piece component with the first portion 46 having a threaded outer surface 48, and the second portion 50 having an enlarged head portion 52.

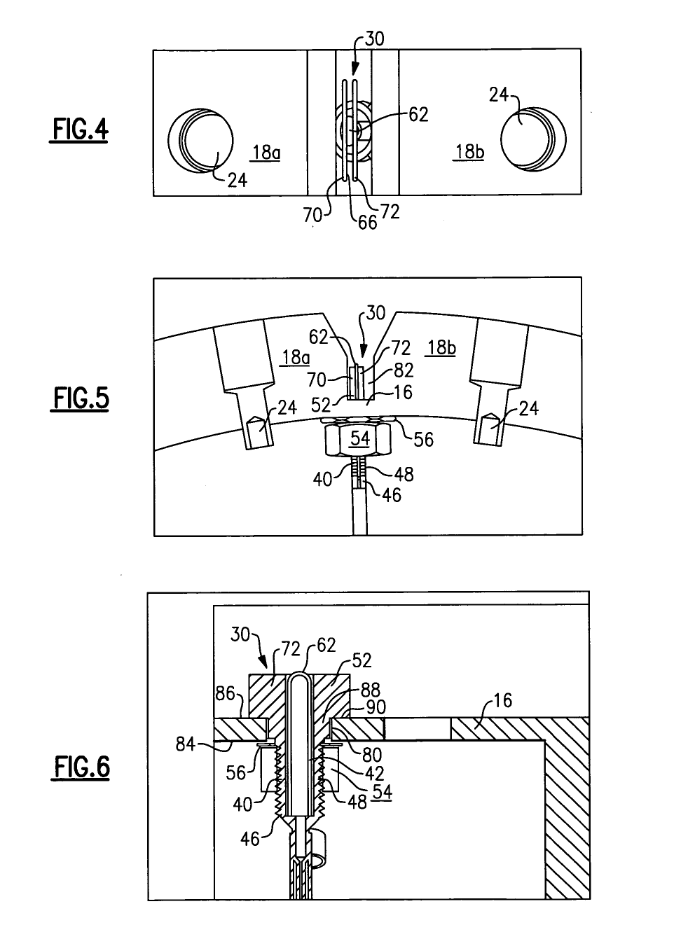

A nut 54 is threaded onto the threaded outer surface 48 to attach the brake lining wear sensor 30 to the plate 16. A spring washer 56 is positioned between the plate 16 and the nut 54 (see FIGS. 5 and 6). The spring washer 56 is used to provide a pre-load force for the attachment interface such that the body 40 is firmly held in place.

The sensor wire 42 is inserted through a bore 60 that is formed within the body 40. The sensor wire 42 includes a single looped portion 62 that extends outwardly beyond an end face 64 of the enlarged head portion 52, as shown in FIG. 3. When the brake lining wear sensor 30 is installed on the plate 16, the single looped portion 62 is positioned at the predetermined maximum brake lining wear level. When the brake lining material wears to this predetermined maximum brake lining wear level, the inner surface 22 of the brake drum 14 will contact the single looped portion 62. This contact will break the single looped portion 62, which will result in the warning signal 36 being sent to the operator. A worker in this art will understand how to provide the appropriate circuitry to achieve this function.

Once the single looped portion 62 is broken the brake drum 14 will continue to contact the brake lining wear sensor 30. The body 40 is preferably formed from a thermoplastic material such that contact between the body 40 and the inner surface 22 of the brake drum 14 will not result in damage to the brake drum 14. Preferably, the body 40 is formed as a single piece by a molding process.

The enlarged head portion 52 includes a slit or slot 66 (FIG. 4) that extends axially from one edge of the enlarged head portion 52 to an opposite edge of the enlarged head portion 52. The slot 66 thus separates the enlarged head portion 52 into first 70 and second 72 head portions.

As shown in FIGS. 2 and 3, the sensor wire 42 is inserted through the bore 60 that initiates in the first portion 46 of the body 40. The bore 60 transitions into the slot 66 (FIG. 4). As shown in FIGS. 5 and 6, the sensor wire 42 is positioned within the bore 60 and the slot 66 such that the single looped portion 62 extends outwardly just beyond the end face 64 of the enlarged head portion 52. When the nut 54 is tightened on the threaded outer surface 48 of the body 40, the sensor wire 42 is clamped between the first 70 and second 72 head portions to securely hold the sensor wire 42 in place.

As shown in FIG. 6, the plate 16 includes an opening 80 that receives the body 40 of the brake lining wear sensor 30. This opening 80 can be a pre-existing opening in the plate 16, such as for a fastener, for example. The opening 80 is positioned between adjacent brake lining blocks 18a, 18b that are separated from each other by a gap 82 (see FIG. 5). Thus, the brake lining wear sensor 30 is not embedded in the brake lining material. This simplifies assembly and reduces cost.

When the brake lining wear sensor 30 is inserted through the opening 80, the first portion 46 of the body 40 extends outwardly from one side 84 of the plate 16, and the second portion 50 extends outwardly from an opposite side 86 of the plate. The body portion includes a flanged area 88 that transitions from the first portion 46 into the enlarged head portion 52. The flanged area 88 is generally received within the opening 80 of the plate 16 such that a bottom end surface 90 of the enlarged head portion 52 abuts directly against the plate 16. When the nut 54 is tightened onto the threaded outer surface 48, the enlarged head portion 52 is securely held in place against the plate 16.

Another example of a brake lining wear sensor 100 is shown in FIGS. 7-10. As shown in FIG. 7, the brake lining wear sensor 100 includes a first portion 102, a second portion 104, and a sensor wire 106 that is received within said first 102 and second 104 portions. The first portion 102 comprises a hollow rivet body 108 and the second portion 104 comprises an insert 110 that is at least partially received within the hollow rivet body 108. A spring washer 112, a nut 114, a resilient member 116, and a spacer 118 cooperate to hold the sensor wire 106 in place within the first 102 and second 104 portions.

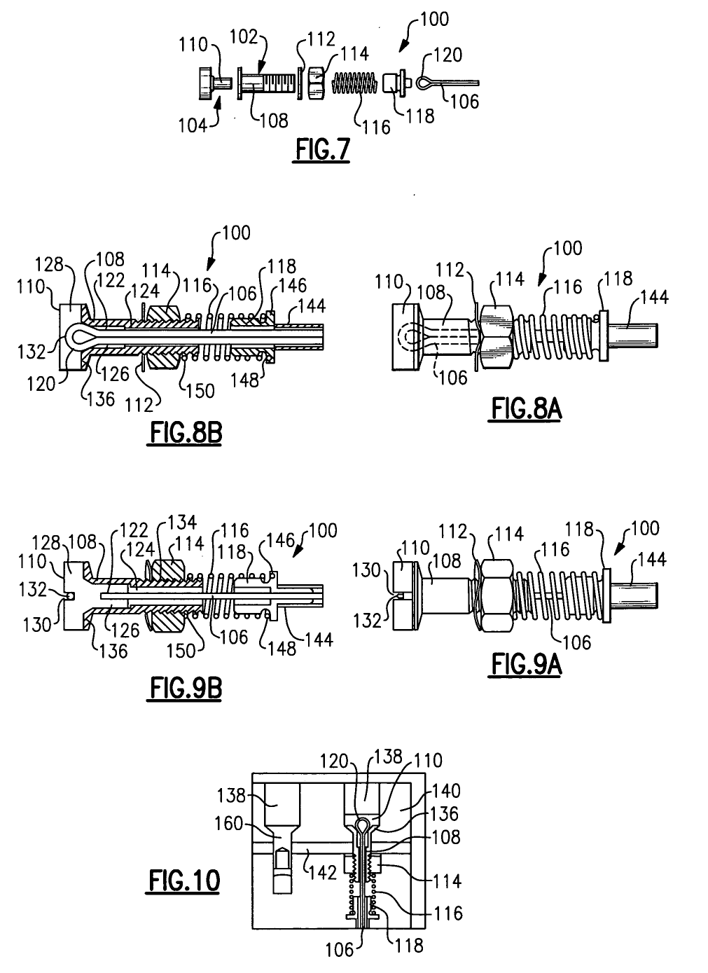

As shown in FIGS. 8A-8B, the sensor wire 106 includes a single looped portion 120 that is mounted within the insert 110. The insert 110 includes a first internal bore 122 and the hollow rivet body 108 includes a second internal bore 124, which are aligned with each other to receive the sensor wire 106. Preferably, the hollow rivet body 108 is comprised of a metal and the insert 110 is comprised of a thermoplastic material that will not damage the drum 14 during contact.

The insert 110 includes a shaft portion 126, which extends into the second internal bore 124, and an enlarged head portion 128 that receives the single looped portion 120. As shown in FIG. 9A-9B, the enlarged head portion 128 includes a slot or opening 130 into which a distal tip 132 of the single looped portion 120 extends. In the example shown, the distal tip 132 does not extend beyond an end face of the enlarged head portion 128, however, the distal tip 132 could extend beyond the enlarged head portion 128 in a manner similar to that shown in FIG. 3.

The hollow rivet body 108 includes a threaded portion 134 formed about an outer surface at one end, and a rivet head 136 formed at an opposite end. The rivet head 136 is inserted into a rivet opening 138 formed in a brake lining block 140 (FIG. 10), and is used to secure the brake lining block 140 to a brake lining support plate 142.

The nut 114 clamps the spring washer 112 against a back side of the brake lining support plate 142. The spacer 118 is coupled to a component 144 (see FIG. 8A) that houses the sensor wire 106. The resilient member 116 comprises a coil spring or other similar type of resilient member that reacts between the nut 114 and the spacer 118. The spacer 118 has a flange portion 146 that abuts against a first spring end 148 and a second spring end 150 abuts against the nut 114. The resilient member 116 cooperates with the various components to hold the sensor wire 106 in place within the first 102 and second 104 portions.

In the example shown, the coil spring surrounds at least a portion of the threaded portion 134 and surrounds the spacer 118. The nut 114 is positioned axially between the spacer 118 and the brake lining support plate 142.

One of the benefits of this configuration is that an existing rivet hole in a brake lining block 140 can be used to house the brake lining wear sensor 100. As shown in FIG. 10, the brake lining block 140 includes multiple rivet openings 138. In the rivet opening on the left, a traditional rivet 160 is used for attaching the brake lining block 140 to the brake lining support plate 142. In the rivet opening 138 on the right, the brake lining wear sensor 100 is used to both attach the brake lining block 140 to the brake lining support plate 142 and additionally provides a brake lining wear indicator.

Although preferred embodiments of this invention have been disclosed, a worker of ordinary skill in this art would recognize that certain modifications would come within the scope of this invention. For that reason, the following claims should be studied to determine the true scope and content of this invention.

What is claimed is:

1. A brake lining wear sensor assembly comprising:
a body having a first portion adapted for attachment to a brake lining support plate, a second portion adapted for engagement with a rotating brake component, and an internal bore extending through said first and said second portions;
a sensor wire received within said internal bore and including a looped portion positioned within said second portion such that said looped portion is at a predetermined brake lining wear level limit; and
a controller that generates a warning signal when said looped portion is broken due to contact with the rotating brake component to indicate that the predetermined brake lining wear level limit has been reached.

2. The brake lining wear sensor assembly according to claim 1 wherein first and said second portions are integrally formed together as a single piece component from a thermoplastic material.

3. The brake lining wear sensor assembly according to claim 1 wherein said first portion comprises a hollow rivet body that secures a brake lining to the brake lining support plate and wherein said second portion comprises an insert that is at least partially received within said hollow rivet body.

4. The brake lining wear sensor assembly according to claim 3 wherein said hollow rivet body is made from a first material and said insert is made from a second material different than said first material.

5. The brake lining wear sensor assembly according to claim 3 including a spacer and a resilient member reacting between said spacer and said hollow rivet body.

6. The brake lining wear sensor assembly according to claim 5 wherein said hollow rivet body includes a threaded outer surface that is threadably engaged with a nut such that said nut is positioned axially between said spacer and the brake lining support plate, and wherein said nut, said spacer, and said spring cooperate to hold said sensor wire at the predetermined brake lining wear level limit.

7. A brake shoe assembly comprising:
a backing plate having an outer plate surface that engages a brake lining and an inner plate surface facing opposite of said outer plate surface;
at least one brake lining block fixed to said backing plate, said at least one brake lining block having an outer block surface that contacts a rotating brake component and an inner block surface that contacts said outer plate surface;
a brake lining wear sensor including a first portion attached to said backing plate, a second portion that engages the rotating brake component after said at least one brake lining block wears to a predetermined wear level, an internal bore extending through said first and said second portions, and a sensor wire received within said internal bore and including a looped portion positioned within said second portion such that said looped portion is held near the predetermined wear level; and
a controller that generates a warning signal when said looped portion is broken due to contact with the rotating brake component to indicate that the predetermined wear level has been reached.

8. The brake shoe assembly according to claim 7 wherein said at least one brake lining block comprises at least first and second brake lining blocks spaced apart from each other by a gap along said backing plate, and wherein said brake lining wear sensor is secured to said backing plate within said gap and between said first and said second brake lining blocks such that said brake lining wear sensor is not embedded within brake lining material.

9. The brake shoe assembly according to claim 8 wherein said first and said second portions are integrally formed together as a single piece component from a thermoplastic material.

10. The brake shoe assembly according to claim 7 wherein said at least one brake lining block includes a fastener opening for receiving a fastener and wherein said brake lining wear sensor is positioned within said fastener opening such that said second portion is substantially surrounded by brake lining material.

11. The brake shoe assembly according to claim 7 wherein said first portion comprises a hollow rivet body that secures said at least one brake lining block to said backing plate and wherein said second portion comprises an insert that is at least partially received within said hollow rivet body.

12. The brake shoe assembly according to claim 11 wherein said insert is comprised of a thermoplastic material.

13. The brake shoe assembly according to claim 11 wherein said insert comprises a hollow body having a shaft portion extending into said hollow rivet body, and having an enlarged head portion that extends outwardly of said hollow rivet body.

14. The brake shoe assembly according to claim 11 including a spacer coupled to a component that houses said sensor wire, and a resilient member reacting between said spacer and said hollow rivet body, wherein said spacer is positioned radially inwardly of said inner plate surface.

15. The brake shoe assembly according to claim 14 wherein said hollow rivet body includes an externally threaded end and including a nut that is threaded onto said externally threaded end to abut a spring washer against said inner plate surface.

16. The brake shoe assembly according to claim 15 wherein said resilient member comprises a coil spring with a first spring end engaging said nut and a second spring end engaging said spacer, and wherein said coil spring is biased to draw said spacer toward said backing plate when said nut is fastened to said hollow rivet body.
